(19) United States
(12) Patent Application Publication
(10) Pub. No.: US 2007/0192590 A1
(43) Pub. Date: Aug. 16, 2007

(54) Mobile Presentable Certificate (MPC)

(75) Inventors: Itzhak Pomerantz, Kefar Saba (IL); Iri Trashanski, Kfar Saba (IL)

Correspondence Address: DR. MARK FRIEDMAN LTD.;C/o Bill Polkinghorn, 9003 Florin Way, Upper Marlboro, MD, 20772, US

(73) Assignee: M-SYSTEMS FLASH DISK PIONEERS LTD.

(21) Appl. No.: 11/497,367

(22) Filed: Aug. 2, 2006

Related U.S. Application Data
(60) Provisional application No. 60/771,795, filed on Feb. 10, 2006.

(51) Int. Cl. H04L 9/00

(52) U.S. Cl. 713/157

(57) ABSTRACT

The present invention teaches systems and methods for validating a user's identity to a validating agent. The system includes a verifiable digital certificate (MPCs—Mobile Presentable Certificates) issued by a certifying authority to a user. The digital certificate is validated by a user device, configured to store and transmit the digital certificate, and an agent device, configured to receive the digital certificate from the user device. Preferably, the devices have a graphical display. MPCs can be transmitted by various communication methods. Verification of MPCs can be performed via a remote certifying authority. MPCs include: a driver's license, a customer discount card, a membership card, a competition-ranking status, and a venue admission ticket. Optionally, MPCs include quadrants which conform to an MPC standard. The method includes issuing an MPC to the user; and transmitting the MPC from a user device to an agent device of the validating agent.

This patent application claims the benefit of U.S. Provisional Patent Application No. 60/771,795 filed Feb. 10, 2006.

### FIELD AND BACKGROUND OF THE INVENTION

The present invention relates to systems and methods for securely issuing, carrying, presenting, and authenticating personal digital certificates using a portable storage device, preferably a portable storage device that has a graphical display.

Personal certificates (e.g. ID cards, driver's licenses, parking permits, and membership cards) serve their owners by being presented to authorized officials (e.g. law enforcement agents, highway patrol officials, and receptionists). In the prior art, these personal certificates typically take the form of plastic cards with printed textual and graphical information, and usually are printed using secure printing methods.

The printed certificate system is intended to present a dependable proof of the identity and status of the owner to the authorized official. There are some major limitations to this system. First, physical cards can be lost and/or stolen. Second, physical cards can only be obtained and updated from special issuing offices. Third, physical cards take up space, thereby increasing the bulk of an owner's wallet. Fourth, presentation of physical cards requires a physical contact between the owner and the official.

It would be desirable to have a system by which the identity and the rights of an individual could be examined by an authorized official without the disadvantages mentioned above.

### SUMMARY OF THE INVENTION

For the purpose of clarity, several terms are specifically defined for use within the context of this application. The term “personal certificate” is used in this application to refer to a document attesting to the truth of certain stated personal facts relating to the carrier of the certificate. The term “digital certificate” is used in this application to refer to a special message signed by a certifying authority that contains the name of a user and his/her public key in such a way that anyone can “verify” that the message was signed by no one other than the certifying authority, and thereby develop trust in the user's public key.

Furthermore, the terms “mobile presentable certificate” and “MPC” are used in this application to refer to a file representing a personal certificate, which can be displayed on the screen of a portable storage device. The term “portable storage device” is used in this application to refer to a device that has a memory for storing data, and can be transported easily by a single individual. A UFD (i.e. USB Flash Disk), a mobile phone, a SIM card of a mobile phone, a notebook computer, and an MP3 music player are examples of portable storage devices.

The expression “examination of an MPC” is used in this application to refer to an operation executed by an official, who is authorized to examine a certificate, in order to verify that the certificate exists, determine that the certificate is valid, and establish that the certificate belongs to the individual that presents the certificate. The term “official” is used in this application to refer to a designated entity authorized to examine and verify a certificate. Examples of officials include law enforcement agents, security guards, store clerks, venue ushers, and automated examining devices. The term “verifiable” is used in this application to refer to a certificate that a validating agent can present to a certifying authority for verification of the authenticity of the certificate.

The terms “certificate visual representation” and “CVR” are used in this application to refer to an MPC represented according to a certain uniform graphical structure and layout defined by a CVR standard. The term “scroll” is used in this application to refer to the act of causing text or graphics to move up, down, or across a display screen. The term “zoom” is used in this application to refer to the act of magnifying various regions of an image. The term “unzoom” is used in this application to refer to the act of de-magnifying various regions of an image. The term “validating” is used in this application to refer to the act of verifying a digital certificate for authenticity.

The present invention utilizes the well-known and established infrastructure of digital certificate authorities (e.g. VeriSign, Inc., 487 East Middlefield Road, Mountain View, Calif. 94043) together with short-range direct communication between mobile phones (e.g. Bluetooth® communication technology), in order to carry and present digital certificates to an authorized official.

In preferred embodiments of the present invention, an authority that wants to use the system of the present invention issues a virtual copy of a physical personal certificate (or membership card) as a digitally-signed, displayable, and optionally-encrypted image file. The file serves as a mobile presentable certificate, or MPC. The MPC is securely sent to the cardholder, and is associated with a specific serial number of a mobile phone, or other portable storage device, provided by the cardholder, typically the portable storage device belonging to the cardholder.

While the MPC can be copied to any portable storage device, the CVR has a special visible indication when the CVR is displayed on the designated portable storage device. This enables a viewer to recognize that the CVR is displayed on the cardholder's portable storage device. The CVR typically has a uniform graphical structure and layout, making the CVR easy for a viewer to recognize the personal certificate represented by the image, and to use the CVR for examination. The certificate visual representation, or CVR, serves as an MPC system standard.

Each MPC has a unique serial number or identifier that is saved with the MPC. The cardholder of the MPC can send the CVR or the MPC serial number from his/her portable storage device to a nearby phone or terminal, by initiating a wireless communication link (e.g. IR, WiFi, or Bluetooth®) between the two devices. The recipient of the CVR or MPC serial number can examine them on his/her own terminal or mobile phone at his/her convenience. If the examiner wants to validate the MPC, the MPC serial number can be sent to a dependable third-party, such as the certifying authority that signed the MPC. The examiner can then have a trusted copy of the MPC downloaded to his/her own terminal or mobile phone.

It is the purpose of the present invention to provide systems and methods, as outlined above, for securely issuing, carrying, presenting, and authenticating personal certificates using a portable storage device, preferably a portable storage device that has a graphical display.

Therefore, according to the present invention, there is provided for the first time a system for validating a user's identity to a validating agent, the system including: (a) a verifiable digital certificate issued by a certifying authority to a user; (b) a user device configured to store and transmit the digital certificate; and (c) an agent device configured to receive the digital certificate from the user device for validating the digital certificate.

Preferably, one or both devices is/are a mobile phone.

Preferably, the user device is configured to store a plurality of the digital certificates and to transmit any one of the digital certificates to the agent device, as selected by the user.

Preferably, one or both devices is/are configured to display the digital certificate.

Preferably, one or both devices is/are configured to scroll, zoom, and unzoom a display image of the digital certificate.

Preferably, each device is configured to display a display image, of the digital certificate, that has a segmentation of at least two sub-areas, each of the sub-areas containing information regarding the digital certificate.

More preferably, the segmentation includes four segments.

More preferably, each of the four segments has a different size, and is positioned at an edge of the display image.

More preferably, the four segments are four quadrants defined by a horizontal separator on the display image perpendicular to a vertical separator on the display image.

Most preferably, at least one of the devices is configured to selectively scroll, zoom, and unzoom each of the four quadrants to substantially fill a display screen of the device.

Preferably, the digital certificate includes an encrypted file.

Preferably, the agent device includes an authentication mechanism for authenticating the digital certificate.

Preferably, the authentication mechanism is configured: (a) to transmit a verification request from the agent device to the certifying authority, wherein the verification request includes at least one digital certificate credential; and (b) to receive a verification response from the certifying authority to the agent device, wherein the verification response indicates whether the digital certificate is authentic.

Most preferably, the digital certificate credential(s) is/are a mobile phone number, a mobile phone serial number, a mobile phone SIM card number, a UFD serial number, an MP3 player serial number, a notebook computer serial number, a digital certificate identification number, or a password.

Preferably, the user device is configured to transmit the digital certificate using a wireless communication method such as IR communication, WiFi communication, or Bluetooth® communication.

According to the present invention, there is provided for the first time a method for validating a user's identity to a validating agent, the method including the steps of: (a) issuing a digital certificate to the user; and (b) transmitting the digital certificate from a user device to an agent device of the validating agent.

Preferred examples of the digital certificate include a driver's license, a customer discount card, a membership card, a competition-ranking status, and a venue admission ticket.

Preferably, the method further includes the step of: (c) verifying at least one user credential, by a certifying authority.

These and further embodiments will be apparent from the detailed description and examples that follow.

### BRIEF DESCRIPTION OF THE DRAWINGS

The present invention is herein described, by way of example only, with reference to the accompanying drawings, wherein:

FIG. 1 shows a simplified schematic diagram of an MPC system, according to a preferred embodiment of the present invention;

FIG. 2 shows a simplified schematic diagram of the general layout of a CVR, according to a preferred embodiment of the present invention;

FIG. 3A shows a driver's license CVR, according to a preferred embodiment of the present invention;

FIG. 3B shows a customer card CVR for a large consumer chain, according to a preferred embodiment the present invention;

FIG. 3C shows an electronic medal CVR, according to a preferred embodiment of the present invention;

FIG. 3D shows a theater ticket CVR, according to a preferred embodiment of the present invention.

### DESCRIPTION OF THE PREFERRED EMBODIMENTS

The present invention relates to systems and methods for issuing, carrying, and presenting personal certificates using a portable storage device. The principles and operation for issuing, carrying, and presenting personal certificates using a portable storage device, according to the present invention, may be better understood with reference to the accompanying description and the drawings.

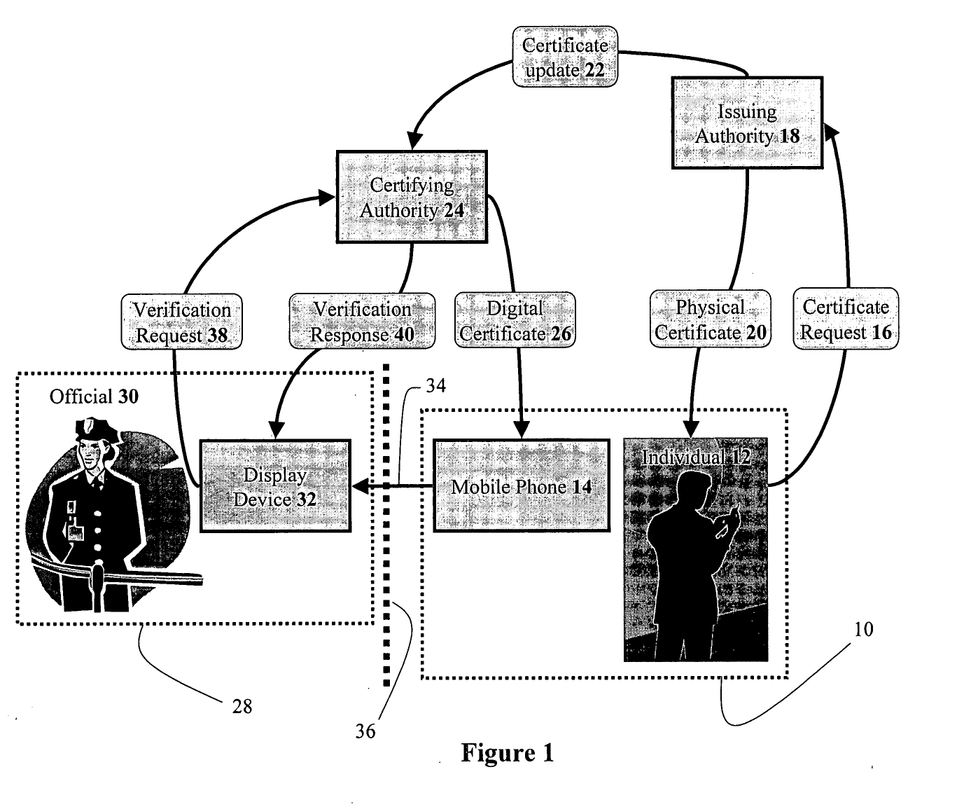

Referring now to the drawings, FIG. 1 shows a simplified schematic diagram of an MPC system, according to preferred embodiment of the present invention. A user 10 is shown as an individual 12 owning a mobile phone 14. Individual 12 submits a certificate request 16 to an issuing authority 18 for a certificate. Issuing authority 18 can be, by way of example, the Department of Motor Vehicles (DMV), and the certificate can be, in this example, a valid driver's license. Submission of certificate request 16 is handled in accordance with the regulations and procedures defined by issuing authority 18, and can involve an interview, an examination, submission of other certificates, among other things.

Issuing authority 18 issues a physical certificate 20 to individual 12 (similar to prior art systems and methods), updates the database (not shown) of issuing authority 18, and sends a certificate update 22 to a certifying authority 24 informing certifying authority 24 that issuing authority 18 has issued physical certificate 20 to individual 12. Individual 12 discloses, as a part of certificate request 16, a device identification number, such as a mobile phone number, phone serial number, or SIM card serial number for the device in which s/he wants to store an MPC. Typically, this device identification number is the cellular phone number of mobile phone 14.

Certifying authority 24 then issues a digitally-signed image file, representing a digital certificate 26 in a visually-displayable format (e.g. .bmp, .jpg, .tiff), and sends the file to mobile phone 14. Digital certificate 26 serves as an MPC that can be displayed as a CVR. Issuance of digital certificate 26 is preferably done in a secure manner. For example, Certifying authority 24 can send individual 12 a low-cost flash-memory card by mail or an encrypted message wirelessly to mobile phone 14 (e.g. an MMS message in the Multimedia Messaging Service standard). Alternatively, certifying authority 24 can provide individual 12 with a password that enables him/her to download digital certificate 26 from the website (not shown) of certifying authority 24. Digital certificate 26 can alternatively be an encrypted file.

Digital certificate 26 is securely stored in mobile phone 14, and the CVR of digital certificate 26 can be displayed on mobile phone 14 upon request. Optionally, the CVR of digital certificate 26 can be displayed on mobile phone 14 upon user identification via a PIN (i.e. Password Identification Number). A program within mobile phone 14 confirms that the CVR of digital certificate 26 that is displayed on mobile phone 14 is an “original” (i.e. the digital certificate 26 is assigned to the mobile phone 14 that is displaying the CVR). If the digital certificate 26 and the mobile phone 14 are not associated with each other, the program either refuses to present digital certificate 26, or clearly marks the CVR as a “copy” rather than an original. Preferably, the serial number of digital certificate 26 is also displayed on mobile phone 14 as a part of the CVR of digital certificate 26.

A validating agent 28 is shown as an official 30 who has a display device 32. Display device 32 can be, for example, the mobile phone of official 30. When official 30 requests individual 12 to present the CVR of digital certificate 26, individual 12 retrieves digital certificate 26 on mobile phone 14, and displays the CVR of digital certificate 26 to official 30. It is noted that official 30 can be any representative for which individual 12 wants to have his/her credentials validated. Official 30 can include, for example, law enforcement officers, security guards, store clerks, venue ushers, and automated examining devices. The purpose of validation can include, for example, identification of individual 12, access to an event or location, or redemption of an award or discount.

Alternatively, individual 12 sends the CVR of digital certificate 26 via a short-range communication link 34 (e.g. IR or Bluetooth®) to display device 32, so that official 30 can examine the CVR on his/her own equipment (i.e. display device 32). This also allows official 30 to send the CVR of digital certificate 26 to his/her back office (not shown) for consulting. Official 30 can also store the CVR of digital certificate 26 (or the serial number of digital certificate 26) in display device 32 for future reference. Clearly, a CVR that is sent to another phone will not be an original, and will be displayed as a copy. This option for remote presentation solves many issues of convenience by eliminating the need for physical contact between validating agent 28 and user 10. For example, a driver's license can be examined through a closed car window 36. It is noted that in the case that official 30 is an automated examining device rather than a human official, display device 32 is not necessary for the validation process.

If official 30 has reasons to doubt the authenticity of the presented CVR, s/he can send a verification request 38 to certifying authority 24, quoting the serial number of digital certificate 26. Official 30 can ask for an official copy of digital certificate 26 to be sent to display device 32. Alternatively, official 30 can upload the CVR from display device 32 to certifying authority 24 and ask for authentication, serving as verification request 38. Certifying authority 24 can then compare the CVR as uploaded to the CVR of the stored digital certificate 26, and issue a verification response 40, either a confirmation or a rejection. It should be noted that direct transmission of the CVR of digital certificate 26 from issuing authority 18, to mobile phone 14 of user 10, can serve as an alternative to transmission of digital certificate 26 from Certifying authority 24 to mobile phone 14 of user 10.

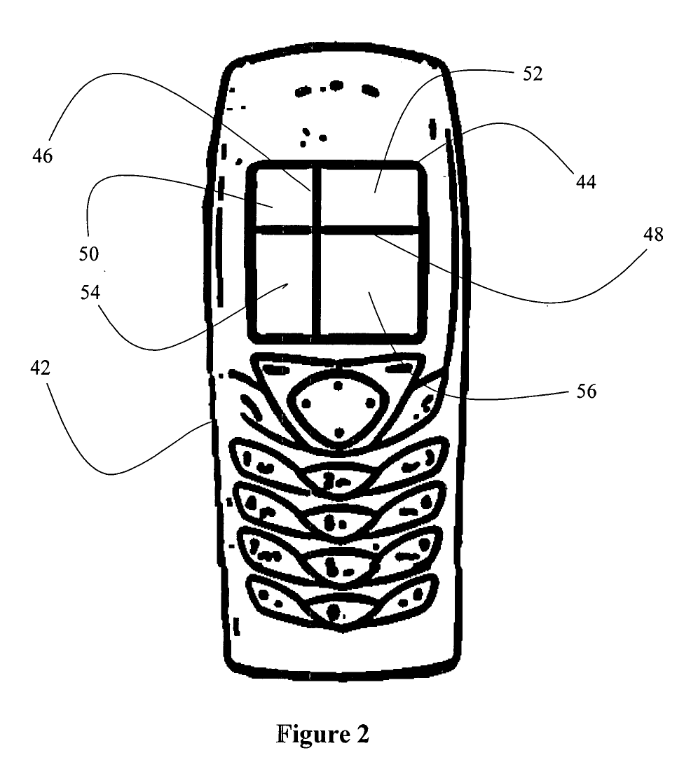

FIG. 2 shows a simplified schematic diagram of the general layout of a CVR 44 (i.e. the CVR of a digital certificate 26 shown in FIG. 1), according to a preferred embodiment of the present invention, as displayed on a mobile phone 42. It is preferable that all CVRs are compatible with a uniform layout, making it easy for official 30 (shown in FIG. 1) to interpret CVR 44. In the preferred embodiment shown in FIG. 2, a vertical line 46 and a horizontal line 48 divide the area of the display of mobile phone 42 into four unequal quadrants of CVR 44. A user of mobile phone 42, such as official 30, can scroll and zoom/unzoom to different regions of interest on CVR 44, using command keys on mobile phone 42.

In a preferred embodiment of the present invention, a top-left quadrant 50 is used to display a logo of issuing authority 18 (shown in FIG. 1), a top-right quadrant 52 is used to display the title of CVR 44, a bottom-left quadrant 54 is used to display a photo of individual 12 (shown in FIG. 1), and a bottom-right quadrant 56 is used to display variable textual information relevant to CVR 44. In addition, a special location within one of quadrants 50, 52, 54, or 56 is used for displaying an identification number of CVR 44. Alternatively, this identification number can be withheld from display by default, and displayed only upon demand, since the identification number is likely to be a long number used only for remote verification request 38 (shown in FIG. 1). Official 30 also has the ability to scroll and zoom/unzoom various regions of CVR 44 on display device 32, using command keys on display device 32.

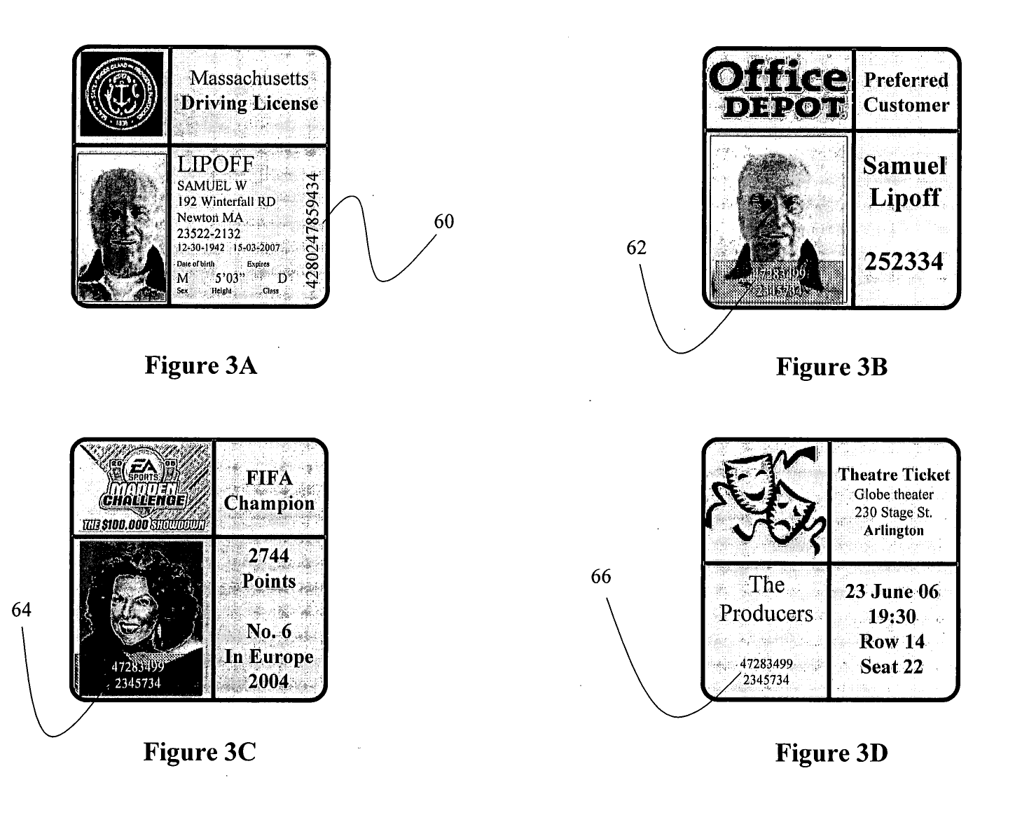

FIGS. 3A, 3B, 3C, and 3D show examples of four typical applications of an MPC, according to preferred embodiment of the present invention. FIG. 3A shows a driver's license CVR, including an MPC identification number 60. FIG. 3B shows a customer card CVR for a large consumer chain, including an MPC identification number 62. FIG. 3C shows an electronic medal CVR, indicating the performance of a gamer, including an MPC identification number 64. FIG. 3D shows a theater ticket CVR, including an MPC identification number 66. It is noted that, according to the present invention, a user has the ability to send multiple CVRs (or MPC serial numbers) to validating agents.

While the invention has been described with respect to a limited number of embodiments, it will be appreciated that many variations, modifications, and other applications of the invention may be made.

What is claimed is:

1. A system for validating a user's identity to a validating agent, the system comprising:
(a) a verifiable digital certificate issued by a certifying authority to a user;
(b) a user device configured to store and transmit said digital certificate; and
(c) an agent device configured to receive said digital certificate from said user device for validating said digital certificate.

2. The system of claim 1, wherein at least one said device is a mobile phone.

3. The system of claim 1, wherein said user device is configured to store a plurality of said digital certificates and to transmit any of said plurality of digital certificates to said agent device, as selected by said user.

4. The system of claim 1, wherein at least one of said devices is configured to display said digital certificate.

5. The system of claim 1, wherein at least one of said devices is configured to scroll, zoom, and unzoom a display image of said digital certificate.

6. The system of claim 1, wherein each said at least one device is configured to display a display image, of said digital certificate, that has a segmentation of at least two sub-areas, each of said at least two sub-areas containing information regarding said digital certificate.

7. The system of claim 6, wherein said segmentation includes four segments.

8. The system of claim 7, wherein each of said four segments has a different size, and is positioned at an edge of said display image.

9. The system of claim 8, wherein said four segments are four quadrants defined by a horizontal separator on said display image perpendicular to a vertical separator on said display image.

10. The system of claim 9, wherein at least one of said devices is configured to selectively scroll, zoom, and unzoom each of said four quadrants to substantially fill a display screen of said at least one device.

11. The system of claim 1, wherein said digital certificate includes an encrypted file.

12. The system of claim 1, wherein said agent device includes an authentication mechanism for authenticating said digital certificate.

13. The system of claim 12, wherein said authentication mechanism is configured:
(a) to transmit a verification request from said agent device to said certifying authority, wherein said verification request includes at least one digital certificate credential; and
(b) to receive a verification response from said certifying authority to said agent device, wherein said verification response indicates whether said digital certificate is authentic.

14. The system of claim 13, wherein said at least one digital certificate credential is selected from the group consisting of: a mobile phone number, a mobile phone serial number, a mobile phone SIM card number, a UFD serial number, an MP3 player serial number, a notebook computer serial number, a digital certificate identification number, and a password.

15. The system of claim 1, wherein said user device is configured to transmit said digital certificate using a wireless communication method selected from the group consisting of: IR communication, WiFi communication, and Bluetooth® communication.

16. A method for validating a user's identity to a validating agent, the method comprising the steps of:
(a) issuing a digital certificate to the user; and
(b) transmitting said digital certificate from a user device to an agent device of the validating agent.

17. The method of claim 16, wherein said digital certificate includes a driver's license.

18. The method of claim 16, wherein said digital certificate includes a customer discount card.

19. The method of claim 16, wherein said digital certificate includes a membership card.

20. The method of claim 16, wherein said digital certificate includes a competition-ranking status.

21. The method of claim 16, wherein said digital certificate includes a venue admission ticket.

22. The method of claim 16, the method further comprising the step of:
(c) verifying said at least one user credential, by a certifying authority.
